(19) United States
(12) Patent Application Publication
(10) Pub. No.: US 2018/0363720 A1
(43) Pub. Date: Dec. 20, 2018

(54) Sealed Spring Devices

(71) Applicant: Zephyros, Inc., Romeo, MI (US)

(72) Inventors: Eren Hursit, Birmingham, MI (US); Ken Makuch, Swartz Creek, MI (US); Joe Surowiec, Rochester, MI (US); Jason Walker, Lenox, MI (US)

(21) Appl. No.: 16/010,670

(22) Filed: Jun. 18, 2018

Related U.S. Application Data
(60) Provisional application No. 62/521,330, filed on Jun. 16, 2017.

(51) Int. Cl. F16F 1/02

(52) U.S. Cl. CPC F16F 1/024

(57) ABSTRACT

A method for sealing a spring comprising providing a spring device, locating an activatable material within the spring device activating the activatable material, and installing the spring device into a desired location after activating the activatable material.

### Technical Field

The present invention relates generally to a spring device having a material for sealing, sound damping, vibration reduction, and/or reinforcement located therein.

### Background

A variety of industries including transportation, construction, furniture, and sporting equipment among others continue to require methods of baffling, reinforcement and sealing that provide improved functionality while simultaneously providing reduced manufacture time, reduced weight and reduced cost.

### SUMMARY OF THE INVENTION

In a first aspect the present teachings contemplate a method comprising providing a metallic spring device, locating an activatable material within the spring device, activating the activatable material, and installing the spring device into a desired location after activating the activatable material. The step of locating the activatable material into the spring may include cutting the activatable material to form individual members. The activatable material may be located into the spring by spraying the material into the spring. The activatable material may be located into the spring by pushing the activatable material into the spring with an automated device or by hand. The activatable material may be sprayed into the spring in a powder form. The spring may be installed in furniture, a transportation vehicle, a sporting good, a building material, or any other structure where springs are traditionally utilized. It is possible that there is a period of at least 24 hours, at least 1 week, at least 4 weeks, at least 1 month, or even at least 1 year, between locating the activatable material into the spring and activating the activatable material. The activatable material may be adapted for forming a sealing material, an acoustical material, an adhesive, a structural foam, or a combination of at least two of the foregoing. The activatable material may be a material that seals the spring device to substantially minimize or prevent vibration. The activatable material may include a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof. The activatable material may have a configuration that is selected from 1) substantially uniform thickness, 2) non-uniform thickness, 3) planar, 4) contoured, 5) geometric, 6) non-geometric, 7) circular cross-section, 8) triangular cross-section 9) rectangular cross-section.

The teachings herein further provide for a device comprising: a spring; and an activatable material located within the spring, the activatable material in a green state; wherein the activatable material is adapted to expand upon exposure to a stimulus.

The teachings herein contemplate a device and method for limiting noise and vibration of spring devices using a sealing body comprising an activatable material. The activatable is located into the spring device in a green state and can be stored and maintained in that green state until eventual contact with a stimulus. It is possible that the activatable material is activated upon contact with a stimulus to expand. Upon exposure to a stimulus, the activatable material may expand to substantially fill the spring and may seal and reinforce the spring and also minimize vibration when the spring is in use.

### DETAILED DESCRIPTION

The present teachings meet one or more of the above needs by the improved sealed spring structures and methods for forming the same as described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein describe a solution for filling spring devices with an activatable material so that vibration of the spring is minimized when the activatable material is activated and the spring is in use. The size of the spring device may vary and the amount of activatable material may be adjusted so that when the activatable material is activated, it may substantially fill the entirety of the area within the confines of the spring device. The thickness of the activatable material may be at least about 0.001 mm. The thickness of the activatable material may be less than about 10 mm. The activatable material may be sprayed into the spring device as a layer.

The spring device may comprise a metallic material. The spring device may comprise a high strength to weight metal, such as aluminum, titanium, magnesium or any combination thereof. The spring device may comprise a steel material. The spring device may comprise a polymeric material. The spring device may comprise any material that facilitates sufficient flexibility to allow for the spring to bend as needed for its intended use, while still maintaining sufficient strength.

The activatable material may be generally dry to the touch or tacky and may be shaped in any form of desired pattern, placement, or thickness, but is preferably of substantially uniform thickness. Though other heat-activated materials are possible for the activatable material, a preferred heat activated material is an activatable polymer or plastic, and preferably one that is foamable. The activatable material layer may be a relatively high expansion foam having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). Preferred thermally activatable materials are disclosed in U.S. Pat. Nos. 7,313,865; 7,125,461; and 7,199,165 incorporated by reference herein for all purposes. For example, and without limitation, the foam may also be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Suitable activatable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104. The activatable material may be die cut extruded sheets of material, which may be machine-inserted into a spring device or inserted by hand. It is also possible that the activatable material may be located into a spring device as a coating, which may be applied by spray-coating, dipping, brush application, or the like.

A number of baffling or sealing foams may also be used for the activatable material. A typical foam includes a polymeric base material, such as one or more ethylene-based polymers which, when compounded with appropriate ingredients (typically a blowing and curing agent), will expand and cure in a reliable and predictable manner upon the application of heat or the occurrence of a particular condition. From a chemical standpoint for a thermally-activated material, the foam is usually initially processed as a flowable material before curing, and upon curing, the material will typically cross-link making the material incapable of further flow.

The activatable material can be formed of other materials provided that the material selected is heat-activated or otherwise activated by an ambient condition (e.g. moisture, pressure, time or the like) and cures under appropriate conditions for the selected application. One such material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. Additional materials may also be used such as those disclosed in U.S. Pat. Nos. 5,766,719; 5,755,486; 5,575,526; and 5,932,680, incorporated by reference herein for all purposes.

It is possible that the activatable material is activated by heat. It is possible that the activatable material is activated by induction. It is possible that the activatable material is chemically activated by a catalyst.

After placement of the activatable material into a spring device, the activatable material may expand and/or cure according to a predetermined set of conditions. For example, exposure to certain levels of heat may cause the activatable material to expand. The volumetric expansion of the activatable material may vary depending upon the sealing and/or baffling needs of a particular cavity. The activatable material layer may expand at least about 100%. The activatable material may expand less than about 2000%. The activatable material may expand at least about 500%, at least about 1000%, or more. The activatable material may expand less than about 1000% or even less than about 500%.

The spring device of the present invention may be installed into an automotive vehicle although it may be employed for other articles of manufacture such as boats, buildings, furniture, storage containers or the like.

Formation of the materials of the present invention may include a variety of processing steps depending on the desired configuration of the materials. The activatable material may be formed by an extrusion process followed by a step of locating the activatable material into the spring device. As one non-limiting example, if the spring has a substantially circular cross section (e.g., a substantially helical spring), it is possible that the activatable material is located into the area within the substantially tube-shaped area formed within the coils of the spring. Upon activation of the activatable material, the activatable material may expand to substantially fill the tube-shaped area within the spring coils. However, the cross section of the spring can be any shape including oval, rectangular, triangular, or any other shape.

The activatable material may also be sprayed into the spring. The activatable material may be located into the spring as a film. The activatable material may be formed into the spring as a coating. The formation and processing may be free of any molding process.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A method comprising:
providing a spring device;
locating an activatable material within the spring device;
activating the activatable material;
installing the spring device into a desired location after activating the activatable material.

2: The method as in claim 1, wherein the step of locating the activatable material into the spring includes cutting the activatable material to form individual members.

3: The method as in claim 1, wherein the activatable material is located into the spring by spraying the material into the spring.

4: The method as in claim 2, wherein the activatable material is located into the spring by spraying the material into the spring.

5: The method as in claim 1, wherein the activatable material is located into the spring by pushing the activatable material into the spring with an automated device or by hand.

6: The method as in claim 2, wherein the activatable material is located into the spring by pushing the activatable material into the spring with an automated device or by hand.

7: The method as in claim 3, wherein the activatable material is located into the spring by pushing the activatable material into the spring with an automated device or by hand.

8: The method as in claim 1, wherein the activatable material is sprayed into the spring in a powder form.

9: The method as in claim 2, wherein the activatable material is sprayed into the spring in a powder form.

10: The method as in claim 5, wherein the activatable material is sprayed into the spring in a powder form.

11: The method as in claim 1, wherein the spring is installed in furniture, a transportation vehicle, a sporting good, a building material, or any other structure where springs are traditionally utilized.

12: The method as in claim 1, wherein there is a period of at least 24 hours, at least 1 week, at least 4 weeks, at least 1 month, or even at least 1 year, between locating the activatable material into the spring and activating the activatable material.

13: The method as in claim 1, wherein the activatable material is adapted for forming a sealing material, an acoustical material, an adhesive, a structural foam, or a combination of at least two of the foregoing.

14: The method as in claim 10, wherein the activatable material is a material that seals the spring device to substantially minimize or prevent vibration.

15: The method as in claim 1, wherein the activatable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

16: The method as in claim 2, wherein the activatable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

17: The method as in claim 3, wherein the activatable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

18: The method as in claim 5, wherein the activatable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

19: The method as in claim 1, wherein the activatable material has a configuration that is selected from 1) substantially uniform thickness, 2) non-uniform thickness, 3) planar, 4) contoured, 5) geometric, 6) non-geometric, 7) circular cross-section, 8) triangular cross-section 9) rectangular cross-section.

20: A device comprising: a spring; and an activatable material located within the spring, the activatable material in a green state; wherein the activatable material is adapted to expand upon exposure to a stimulus.
